(19) United States
(12) Patent Application Publication
(10) Pub. No.: US 2007/0132247 A1
(43) Pub. Date: Jun. 14, 2007

(54) Electric power generation system

(76) Inventors: Stephen Galayda, Auburn, WA (US); Michael Galayda, Gig Harbor, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 10/547,755

(22) PCT Filed: Mar. 3, 2004
(86) PCT No.: PCT/US04/06423

§ 371 Date: Jun. 12, 2006

Related U.S. Application Data
(60) Provisional application No. 60/452,225, filed on Mar. 3, 2003.

(51) Int. Cl. F03D 9/00; H02P 9/04

(52) U.S. Cl. 290/44

(57) ABSTRACT

An electric generating system configured to use the force of wind to drive at least one wind pump that pumps fluid in a hydraulic system for driving a hydroelectric generator. The wind pump has a blade assembly with blade boundary characteristic and pitch controls. The wind pump includes an inductive power supply. A standby-pump provides pressurized fluid in the hydraulic system when the wind is insufficient to power the system. An efficient and adaptable control system is employed, enabling the generating system to reliably provide power to an electric grid.

### BACKGROUND OF THE INVENTION

1. Field of the Invention

The present invention is directed to an electric power generation system, and more particularly, to a wind-based hybrid electric power generation system that is efficient and reliable.

2. Description of the Related Art

Wind-driven generators are transducers that utilize moving air to generate electrical energy. In a typical wind-generator system, an impeller is driven by the wind, which in turn drives a transmission system to achieve a mechanical advantage for driving a device to generate electricity, such as a direct current electrical generator or an alternator.

An example of a known wind-driven generator system is discussed in U.S. Pat. No. 2,539,862 issued to Rushing (“Rushing”). Rushing uses a wind wheel or impellers to drive a plurality of pumps or compressors. The pumps or compressors pump a fluid that is stored under pressure. The pressurized fluid is used to operate an electrical generator. The pitch of the wind wheel blades or impellers is fixed and the speed of the wind wheel or impellers is controlled by selectively throwing into or out of operation the proper size pump or compressor. A stand-by power source supplies hydraulic pressure when there is no wind.

Another wind-driven generator system is discussed in U.S. Pat. Nos. 4,496,846, 4,496,847 and 4,498,017 (collectively “Parkins”). Parkins uses a wind machine to turn a shaft that activates a multistage pump. Parkins employs a fixed pitch rotor but notes that variable pitch rotors may be used. Selective stages of the multistage pump are removed or added from effective pumping to control the torque of the shaft. A hydraulic system connects a number of wind machines in parallel to drive a single turbine installation.

Another wind-driven system is discussed in U.S. Pat. No. 4,083,651 issued to Cheney. Cheney uses a selectively off-set pendulum pivotally connected to a wind turbine and a blade for torsional twisting of the blade to control speed.

Current wind-powered electric generating methods are limited by several disadvantages that have historically made wind power an undesirable primary or alternate source of energy for large utilities. The disadvantages include an inability to take advantage of economy of scale, duplication of systems, high maintenance costs, and an inability to provide large blocks of reliable, firm power.

### BRIEF SUMMARY OF THE INVENTION

The disclosed embodiments of the present invention are directed to a hybrid electric generating system configured to use the force of wind to drive wind pumps that pump fluid in a hydraulic system for driving a hydroelectric generator. In one embodiment, the wind pump has an adjustable blade assembly for controlling blade boundary characteristics and blade pitch and the system has a standby-pump system to pump fluid in the hydraulic system when the wind is insufficient to power the system. In another embodiment, the wind pump has an inductive power supply to provide power to the adjustable blade assembly. An efficient and adaptable control system is employed, enabling the generating system to reliably provide power to an electric grid.

In another embodiment, the system has at least one wind pump with an adjustable blade assembly, a gearbox system coupled to the blade assembly and a fluid pump coupled to the gearbox system. The wind pump and a standby pump are coupled to a hydraulic system, which is coupled to a generator. A control system generates a control signal for controlling the system. For example, the control system may generate a control signal for controlling the standby pump based on a signal corresponding to a condition of the hydraulic system. Alternatively, the system may generate control signals for maintaining a desired power output of the generator.

In another embodiment, the system has at least one device for converting wind into a rotational force coupled to a device for converting the rotational force into a force that drives a first fluid pump. The system has a second device for converting a second force into a force to drive another fluid pump. The system has a tower to store the pumped fluid coupled to a device for releasing the stored fluid, which in turn is coupled to a generator. The system has a controller to control the device for converting wind into a rotational force and a controller to control the system so as to substantially maintain a selected amount of stored fluid in the tower.

In another embodiment, the system has at least one wind pump with an adjustable blade assembly, a gearbox system coupled to the blade assembly and a fluid pump coupled to the gearbox system. The wind pump and a standby pump are coupled to a hydraulic system, which is coupled to a generator that has an output. A control system generates a control signal for controlling the standby pump based on the output of the generator.

In another embodiment, the system has at least one wind pump and a standby pump, both coupled to a hydraulic system. The hydraulic system is coupled to and drives a generator having an output. The system has a controller which receives a signal corresponding to a condition of the hydraulic system and generates a control signal for substantially maintaining a selected level of the output of the generator.

In another embodiment, a wind blade assembly for a wind pump has a blade with an adjustable leading slat assembly and an adjustable trailing slat assembly. The blade is coupled to a drive shaft. In another embodiment, an optional pitch control assembly is coupled to the wind blade. In another embodiment, a first coil is coupled to the drive shaft and is rotatable with respect to a second coil.

In another embodiment, a wind blade assembly has a wind blade and a device for controlling a boundary layer characteristic of the wind blade assembly in response to a control signal. In another embodiment, an inductive power supply device is coupled to the wind blade assembly.

In another embodiment, a wind pump has a blade coupled to a hydraulic system and a device for adjusting a boundary layer characteristic of the blade. In another embodiment, a device for adjusting a pitch is coupled to the blade.

In another embodiment, a power transformer has a stationary frame and a rotatable shaft having an axis. A primary coil is mounted on the stationary frame and has windings concentric to the axis of the rotatable shaft. A secondary coil is mounted to the rotatable shaft and has windings concentric to the axis of the rotatable shaft. The rotatable shaft can be mounted on the stationary frame with an optional thrust bearing.

### BRIEF DESCRIPTION OF THE SEVERAL VIEWS OF THE DRAWINGS

FIG. 1 is an operational schematic of an embodiment of a hybrid electric power generating system formed in accordance with the present invention.

FIG. 2 is a schematic of a wind pump tower assembly suitable for use in the embodiment of FIG. 1.

FIG. 3 is a schematic view of a wind pump nacelle of the embodiment of FIG. 2.

FIG. 4 is a partial cross-sectional view of a wind pump tower of the embodiment of FIG. 2.

FIG. 5 is a schematic view of a wind pump tower base of the embodiment of FIG. 2.

FIG. 6 is a partial cross-sectional closed view of a wind blade taken along lines 6, 7-6, 7 of the embodiment of FIG. 3.

FIG. 7 is a partial cross-sectional open view of a wind blade taken along lines 6, 7-6, 7 of the embodiment of FIG. 3.

FIG. 8 is a schematic view of a rotating control and power module suitable for use with the embodiment of FIG. 3.

FIG. 9 is a partial cross-sectional view of a portion of the rotating control and power module of FIG. 8.

FIG. 10 is a partial cross-sectional view taken along lines 10-10 of the rotating control and power module of FIG. 8.

FIG. 11 is a functional block diagram of a nacelle control system suitable for use with the embodiment of FIG. 2.

FIG. 12 is a functional block diagram of a control system suitable for use with the embodiment of FIG. 1.

FIG. 13 is a functional block diagram of a blade boundary characteristic and pitch control system suitable for use with the embodiment of FIG. 2.

### DETAILED DESCRIPTION OF THE INVENTION

The present invention provides for a hybrid electric generator having an efficient transmission system. Embodiments of the invention will be described using a limited number of representative examples and drawings.

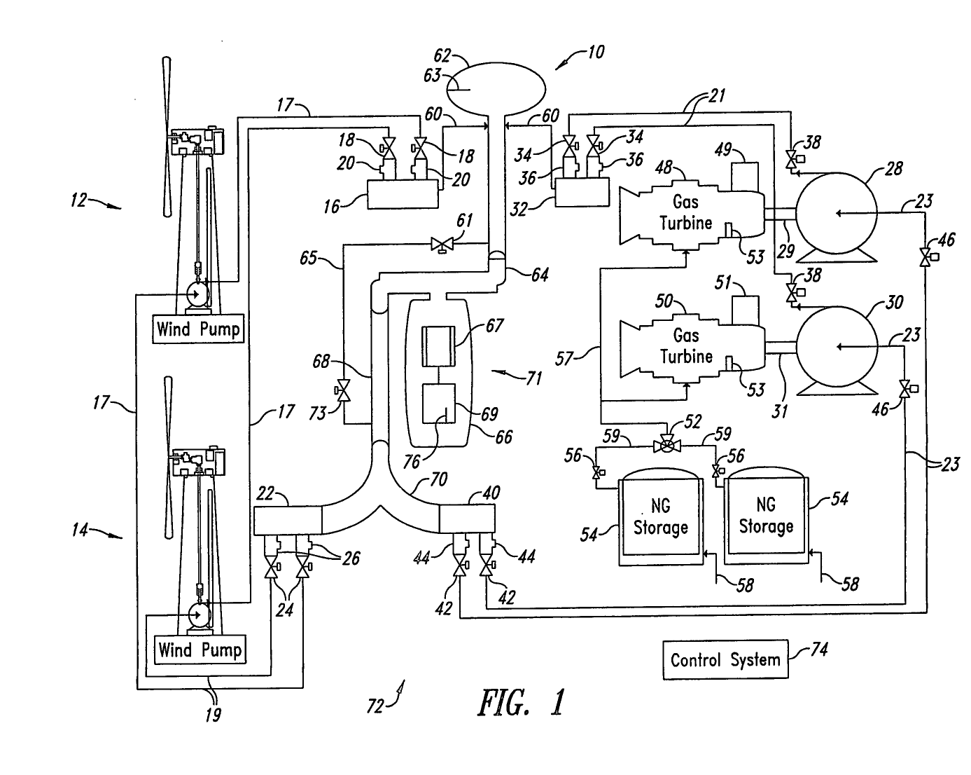

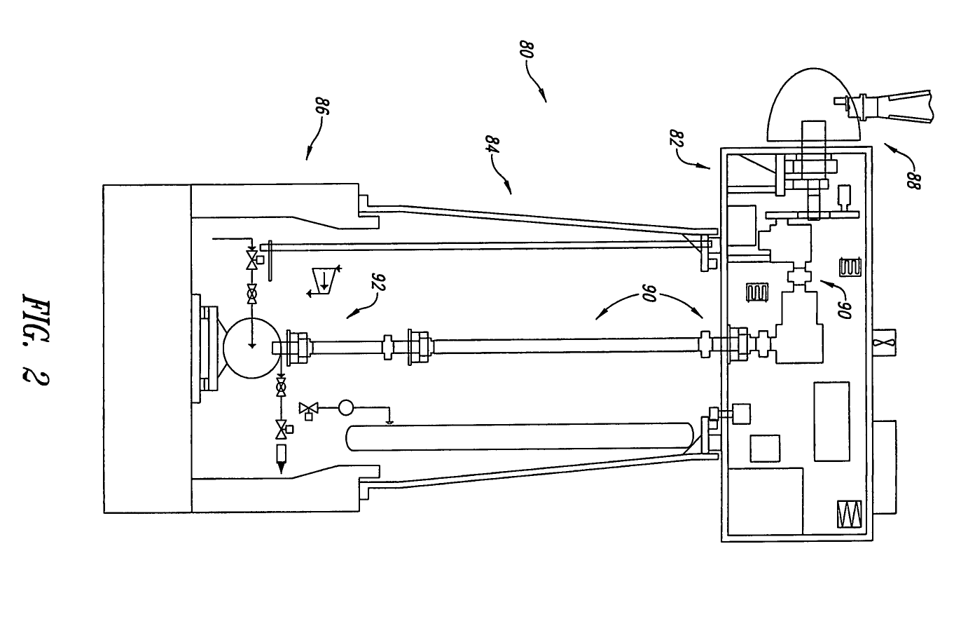

Referring initially to FIG. 1, shown therein is a hybrid electric power generating system 10. The system 10 includes first and second wind pumps 12, 14, each of which is coupled to a first supply or inlet manifold 16 through a pipe 17. Associated with the pipe 17 are a flow control valve 18 and a flow sensor 20. The first and second wind pumps 12, 14 are also coupled to a first suction or outlet manifold 22 through a pipe 19, that has associated with it a flow control valve 24 and a flow sensor 26. A single wind pump or additional wind pumps (not shown) may be employed. As discussed in more detail below, the wind pumps 12, 14 pump fluid, and the flow control valves 18, 24, may be configured to open and close manually, either in response to control signals or to changes in fluid pressure or flow or to some combination thereof, to regulate the fluid flow. In addition, the flow sensors 20, 26, gather information, such as a fluid pressure or a flow volume, that can be used to control various components of the system 10. Additional pipes, manifolds, flow control valves, and sensors (not shown) may be employed, as well as alternative arrangements of pipes, manifolds, flow control valves and sensors. An exemplary wind pump is described in more detail below with regard to FIGS. 2 through 5.

The system 10 includes first and second standby pumps 28, 30, each of which is coupled to a second supply or inlet manifold 32 through a pipe 21 that has associated with it a flow control valve 34, a flow sensor 36 and an isolation valve 38. The first and second standby pumps 28, 30 are also coupled to a second suction or outlet manifold 40 through a pipe 23 that has associated with it a flow control valve 42, a flow sensor 44, and an isolation valve 46. As discussed in more detail below, the first and second standby pumps 28, 30 pump fluid, and the flow control valves 34, 42, and the isolation valves 38, 46 are configured to open and close, either manually or in response to control signals or to changes in fluid pressure or to some combination thereof, to regulate fluid flow. In addition, the flow sensors 36, 44, gather information, such as a fluid pressure or a fluid flow volume, that can be used to control various components of the system 10. The isolation valves 38, 46 permit isolation of a standby pump, such as the first standby pump 28, from the manifolds, such as the second inlet manifold 32, when maintenance needs to be performed. A single standby pump or additional standby pumps (not shown) may be employed. Additional pipes, manifolds, flow control valves, sensors and isolation valves (not shown), as well as alternative arrangements of pipes, manifolds, flow control valves, sensors and isolation valves may be employed. In an exemplary embodiment, the first and second standby pumps 28, 30 are low head, high flow pumps.

The first and second standby pumps 28, 30 are coupled by first and second connecting shafts 29, 31, to first and second turbines 48, 50, which provide a variable power supply to drive the standby pumps 28, 30. The first and second turbines 48, 50 are coupled to a gas-mixing valve 52 through pipes 57. The first and second turbines 48, 50, are coupled to first and second throttle controls 49, 51, respectively. Each gas turbine 48, 50 has a gas turbine speed sensor 53. The gas-mixing valve 52 is coupled to two gas storage tanks 54 through two gas control valves 56 and pipes 59. The gas storage tanks 54 receive gas from a gas pipeline 58. The gas-mixing valve 52 and the gas control valves 56 open and close either manually or in response to control signals. Alternative arrangements to supply gas to the first and second turbines 48, 50, as well as alternative sources of fuel, such as other fossil or biomass fuels, may be employed. The standby pumps could also be driven by other sources of energy (not shown) as are known to those skilled in the art.

The first and second inlet manifolds 16, 32 are coupled through large pipes 60 to a water tower 62. While the description of the drawings refers to a water tower 62, any suitable hydraulic fluid may be used. The water tower 62 has a level detector 63 and is coupled to a hydro-turbine inlet penstock 64. As discussed in more detail below, the inlet penstock 64 opens and closes in response to control signals or to changes in system pressure or some combination thereof.

The inlet penstock 64 is coupled to a hydroelectric generator 66 which collectively form a hydro turbine assembly 71. The hydroelectric generator 66 has a hydroturbine impeller 67 coupled to an electric generator 69, which has a power sensor 76. The hydroelectric generator 66 converts the potential energy of the fluid stored in the water tower 62 into electrical energy. Additional inlet penstocks and hydroelectric generators (not shown) may be employed, and a single inlet penstock may feed more than one hydroelectric generator.

The inlet penstock 64 is coupled to a penstock connection 68, which is coupled to an outlet penstock 70. The outlet penstock 70 is coupled to the first and second outlet manifolds 22, 40. In an exemplary embodiment, the large pipes 60, the inlet manifolds 16, 32 and the outlet manifolds 22, 40 are large diameter pipes constructed of corrosion resistant materials with a smooth inner wall to minimize fluid friction and head loss. Similarly, using a large radius for any bends in the pipe will minimize head loss.

Collectively, the pipes 17, 19, 21, 23, 57, and 59, flow control valves 18, 24, 34, and 42, flow sensors 20, 26, 36, and 44, first and second inlet manifolds 16, 32, first and second outlet manifolds 22, 40, isolation valves 38, and 46, large pipes 60, water tower 62, water level detector 63, inlet penstock 64, penstock connection 68 and the outlet penstock 70 comprise a hydraulic system 72. The hydraulic system 72 may contain additional components or alternative arrangements of components. A control system 74 controls the operation of the hydroelectric power generation system 10. Components of the system 10 may receive control signals generated by the control system 74. For example, the first and second throttle controls 49, 51, and the hydraulic system 72 may receive control signals from the control system 74. The control system 74 may receive data signals from components of the system 10. For example, the control system 74 may receive data signals from the hydraulic system 72. Signal lines (not shown) and power lines (not shown) may be coupled to components of the system 10.

The water tower 62 collects the discharge from the wind pumps 12, 14 and standby pumps 28, 30, converting the flow energy of the fluid into potential energy. That fluid then exits the water tower 62 and enters the inlet penstock 64. The optimum range of height of fluid in the water tower 62 is a matter of design choice that typically will depend on the head requirements of the inlet penstock 64.

The water tower 62 also serves as a surge volume for the wind pump 12, 14 and standby pump 28, 30 discharges, and it provides system inertia to smooth inevitable transients that will occur as a result of wind speed fluctuations and standby pump 28, 30 lag times. During optimal wind periods, most of the fluid entering the water tower 62 will be from the wind pumps 12, 14. If the fluid level in the water tower 62 drops because, for example, of a decrease in wind speed, level detector 63 will send a signal to the control system 74. In response, the control system 74 will generate control signals to control the first and second throttle controls 49, 51 to operate or speed up the gas turbines 48, 50 so that the standby pumps 28, 30 can make up the difference and restore or maintain the fluid level in the water tower 62. As the fluid level approaches a desired level, the level detector 63 will feed a signal to the control system 74. At the same time, speed sensors 53 on the gas turbines 48, 50 provide negative feed back to the control system 74; that is, as the gas turbines 48, 50 speed up, the control system 74 sends control signals to the first and second throttle controls 49, 51 to adjust the power provided to the standby pumps 28, 30. These signals are combined by the control system 74 to prevent the system 10 from overshooting the normal operating level, and to prevent oscillations in the fluid level in the water tower 62. As the wind returns, the process reverses to slow the gas turbine and maintain the desired fluid level in the water tower 62.

The fluid level in the water tower 62 maintains the system pressure. The relationship between the pressure in the inlet manifolds 16, 32 and the fluid level in the water tower 62 can be approximated as follows:
pₛ=ρgh
where ρₛ is the pressure in the inlet manifolds 16, 32; ρ is the density of the fluid, which is 62.43 pounds per cubic foot for water; g is the acceleration due to gravity, which is 32 feet per second squared; and h is the height of the fluid in the water tower 62 above the inlet manifolds 16, 32. Because ρ and g are constants, pressure is referred to as head, and is measured in feet. By maintaining the level of the fluid in the water tower 62 substantially constant, the pressure in the inlet manifolds 16, 32, or head, remains substantially constant. The control system 74 may be configured to control operation of the system 10 to minimize fluctuations in fluid level and thus in the supply manifold pressure.

The hydroelectric generator 66 converts the potential energy of the fluid in the water tower 62 into electrical energy. The fluid exiting the water tower 62 passes through the inlet penstock 64 into the hydroelectric generator 66. There it imparts its energy to the hydro turbine impeller 67 in the hydroelectric generator 66. The impeller 67 drives the electric generator 69. The inlet penstock 64 controls the amount of water that enters the hydro turbine assembly 71 and thus controls the hydro turbine assembly 71 output torque.

When the hydroelectric generator 66 is connected to the power grid (not shown), its output frequency is held constant by the power grid (at 60 Hz in the United States). Even if the torque provided by the hydro turbine assembly 71 is reduced, the output frequency and hence the speed of the electric generator 69 will remain constant. However, the electric generator 69 power output will decrease proportionally to a decrease in torque of the hydro turbine assembly 71. This situation could arise when the fluid level in the water tower 62 briefly decreases, reducing the head available for the inlet penstock 64, until the standby pumps 28, 30 can restore the fluid level. The control system 74 can be configured to respond to a reduction in output power by generating control signals to open the inlet penstock 64 slightly to maintain the desired power output.

During startup of the hydroelectric generator 66, approximately one hundred percent of full rated flow may be available from the combined outputs of the wind pumps 12, 14 and the standby pumps 28, 30, which will allow the hydroelectric generator 66 to be fully loaded without undue delay. However, until the hydroelectric generator 66 is supplying its rated capacity, the inlet penstock will not be passing all of the fluid accumulating in the water tower. This imbalance will cause the fluid level in the water tower 62 to quickly rise. To address this, a by-pass line 65 allows dumping of fluid from the water tower 62 to the outlet manifolds 22, 40. The by-pass flow is throttled by an adjustable by-pass flow control valve 61 to maintain the desired fluid level in the water tower 62. When by-pass flow is not required during normal operations, the by-pass line is secured by closing a flow control valve 73. Similarly, if the hydroelectric generator 66 goes off line suddenly during high-flow conditions, the inlet penstock 64 will secure flow to the hydroelectric generator 66, and the water level will quickly rise in the water tower 62. The control system 74 can be configured to generate control signals to open adjustable by-pass flow control valve 61 and flow control valve 73 to dump fluid from the water tower 62 to the output manifolds 22, 40 until flow from the wind pumps 12, 14 and the standby pumps 28, 30 can be secured.

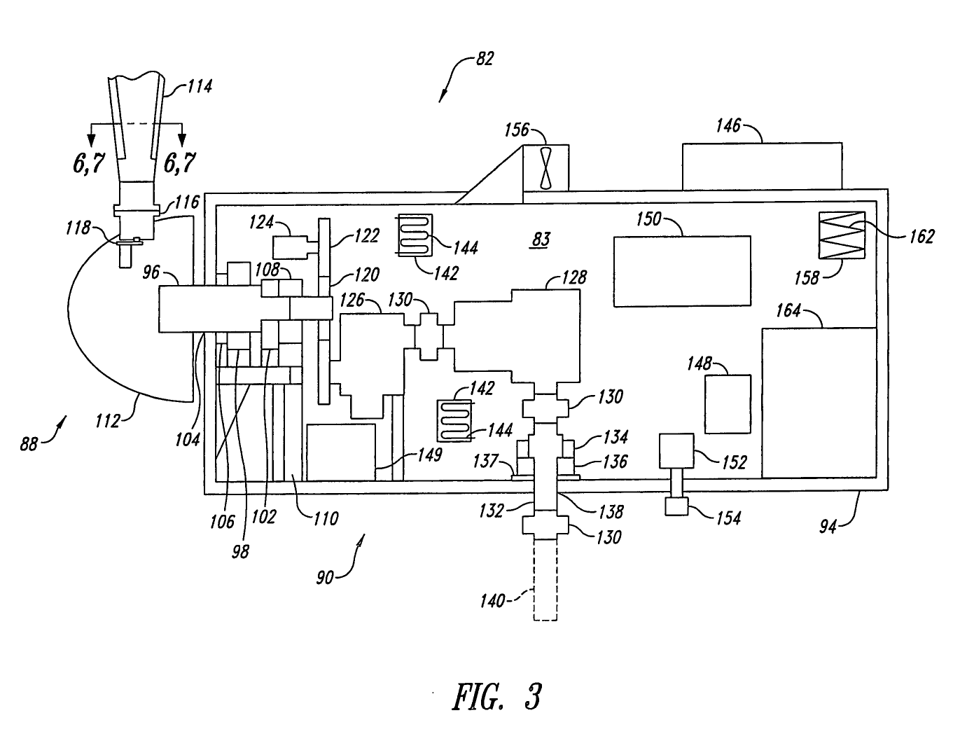

FIGS. 2 illustrates an exemplary wind pump 80 that may be employed, for example, as the wind pumps 12, 14 of the system 10 of FIG. 1. The wind pump 80 has a nacelle 82 mounted on a pump tower 84 that is supported by a pump tower base 86. The nacelle 82 houses a blade assembly 88 and a portion of a gearbox system 90. The gearbox system 90 extends from the nacelle 82 down the pump tower 84 and into the pump tower base 86. The pump tower base 86 houses a fluid pump system 92 coupled to the gearbox system 90. These assemblies are illustrated in greater detail in FIGS. 3-5.

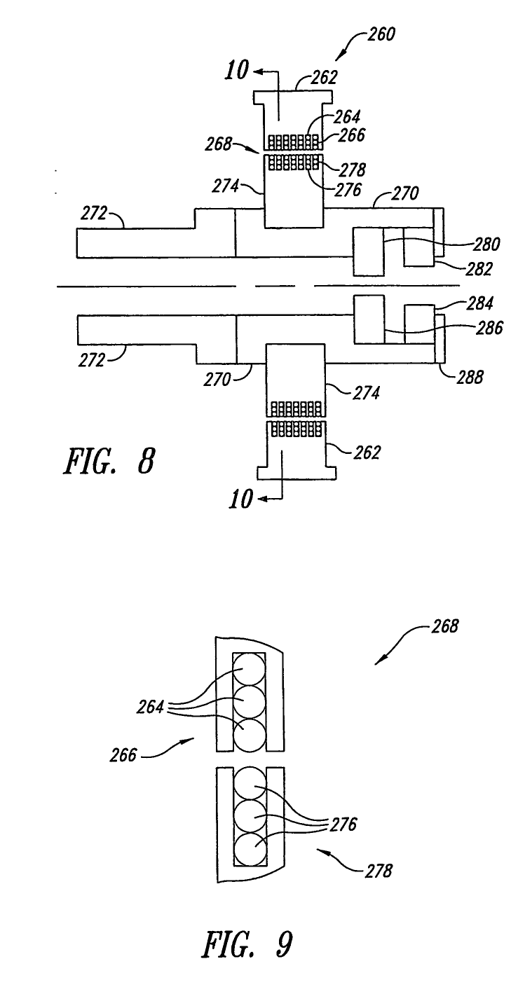

FIG. 3 illustrates the nacelle 82, the blade assembly 88, and a portion of the gearbox system 90 of FIG. 2 in greater detail. The nacelle 82 has a housing 94. A portion of a blade drive shaft 96 is rotationally secured in the housing 94 by a radial bearing 98 and a thrust bearing 102. A portion of the blade drive shaft 96 extends out of the housing 94 through an opening 104. A weather seal 106 helps to protect the interior 83 of the nacelle 82 from the environment. The blade drive shaft 96 is coupled to a rotating power and control module 108. The rotating power and control module 108 is coupled to the nacelle housing 94 by support 110. An exemplary rotating power and control module is illustrated in greater detail in FIGS. 8-10.

The portion of the blade drive shaft 96 extending outside the housing 94 is coupled to a spinner 112. A wind blade 114 is coupled to the spinner 112 by a blade mount 116, which is coupled to a blade pitch control drive 118. Additional wind blades (not shown) may be coupled to the spinner 112. The dimensions and number of wind blades (such as the wind blade 114 illustrated) are a matter of design choice. The wind blade 114 is similar in design and function to aircraft wings.

Pitch is the angle between the leading edge of a wind blade (such as the wind blade 114 illustrated) and a wind. When the pitch is zero, no lift is produced, and the wind blade 114 produces no torque. Maintaining a zero pitch is called feathering and is useful when the wind pump 80 (see FIG. 2) needs to be stopped for maintenance or when weather conditions are such that damage to the wind pump 80 may occur if it is operated. As the pitch is increased, force is applied to the wind blade 114 as a result of the lift created by the wind passing over the wind blade 114. This force causes the wind blade 114 to rotate around the spinner 112. The optimum pitch for a given wind and load condition and blade arrangement is a matter of design choice.

The blade drive shaft 96 is coupled to a flywheel assembly 120. A gear assembly 122 couples the flywheel assembly 120 to an inertia brake motor 124. The flywheel assembly 120 is coupled to a reduction gearbox 126. The inertia brake motor 124 selectively engages the flywheel assembly 120 to supply starting torque as needed. The reduction gearbox 126 contains gears and transfer shafts (not shown) and is coupled to a ninety degree reduction gear box 128 by a shaft coupling 130. The ninety-degree reduction gearbox 128 is coupled to a first transfer shaft 132 by a shaft coupling 130. The first transfer shaft 132 is rotationally secured to the housing 94 by radial bearings 134 and thrust bearings 136. A weather seal 137 helps to protect the interior 83 of the nacelle 82 from the environment. The first transfer shaft 132 extends through an opening 138 in the housing 94. The first transfer shaft 132 is coupled to a second transfer shaft 140 by a shaft coupling 130. The gearbox system 90 employs oil coolers 142 to cool the gearbox system 90 and oil strainers 144 to clean the oil.

In an exemplary embodiment, the wind pump drive shaft 96 operates at very low rotational speeds and the pump system 92 (see FIG. 2) it drives operates at much higher speed. The gearbox system 90 converts the low speed of the wind pump drive shaft 96 to the operational speed of the pump system 92. The increased output speed of the gearbox system 90 also allows the transmission of high values of torque with a lightweight drive shaft. In an exemplary embodiment, the drive shaft 96 is hollow. Hollow shafts tolerate greater torsion loads than solid shafts of the same weight. The capacity of the gearbox system 90 is a matter of design choice.

A weather station 146, a yaw control system 148, a blade control system 149 and a main nacelle control 150 are secured to the nacelle housing 94. A yaw drive motor 152 is secured to the housing 94 and coupled to a yaw gear assembly 154. The nacelle 82 has an exhaust fan 156 and an air inlet 158 to facilitate cooling of the interior 83 of the nacelle 82. Filters 162 are used to filter air coming in the air inlet 158. A counter balance 164 is coupled to the nacelle housing 94 to counter loads created by the blade assembly 88 and the portion of the gearbox assembly 90 in the nacelle 82.

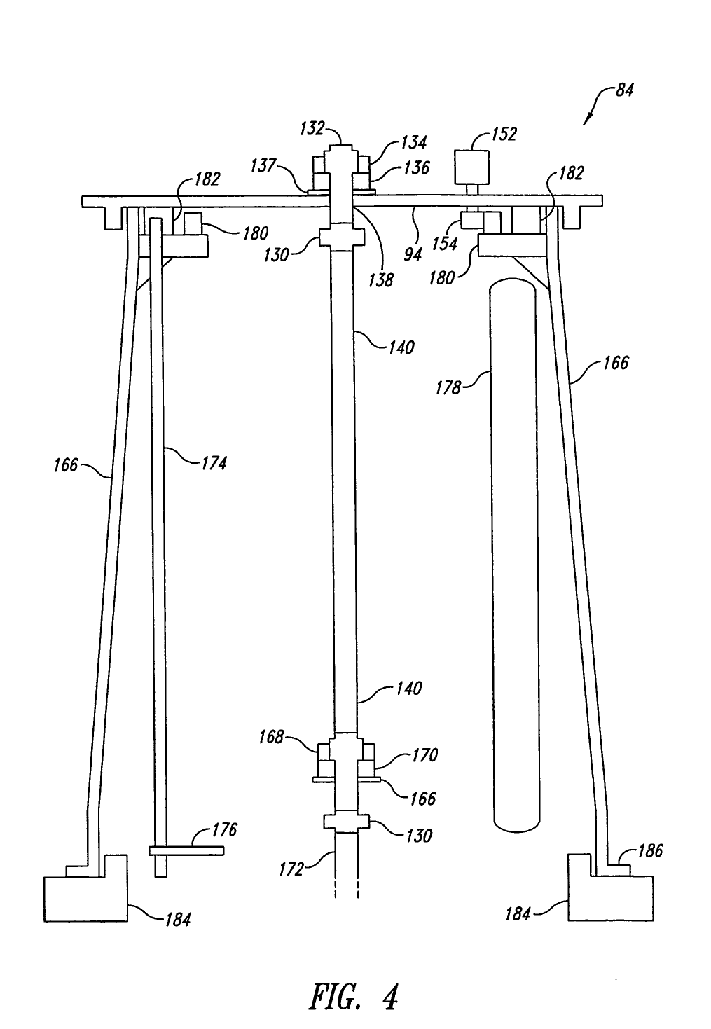

For optimum performance, the plane in which the wind blade 114 rotates must be orthogonal to the wind, with the spinner 112 facing into the wind. The yaw control system 148 generates control signals to cause the yaw drive motor 152 to drive the yaw gear assembly 154. The yaw gear assembly engages a yaw ring gear assembly 180 (see FIG. 4) and turns the nacelle 82 into the wind. In an exemplary embodiment, the yaw control system 148 automatically generates control signals to maintain an optimum yaw of the nacelle 82. The yaw control system 148 may also compensate for the effects of gyroscopic precession. Precession is a force that acts on a spinning object at an angle to its axis. It is the force that keeps a spinning top from falling over. However, if not properly accounted for, it can cause damage to the wind pump 80 (see FIG. 2).

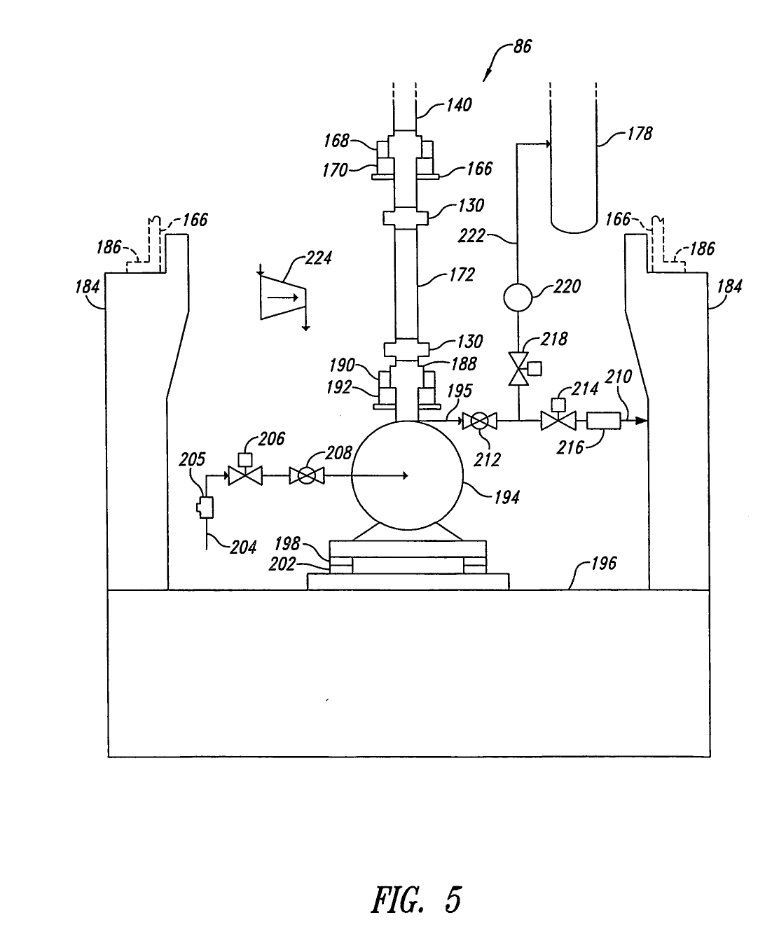

FIG. 4 is a partial cross-sectional view illustrating the wind pump tower 84 of the wind pump 80 of FIG. 2 in greater detail. The nacelle housing 94 is secured to a tower structure 166. The first transfer shaft 132 is rotationally coupled to the nacelle housing 94 by radial bearing 134 and thrust bearing 136. A weather seal 137 helps to protect the interior 83 (see FIG. 3) of the nacelle 82 (see FIG. 3) from the environment. The first transfer shaft 132 extends out of the housing 94 through opening 138 and is coupled to the second transfer shaft 140 by a shaft coupling 130. The second transfer shaft 140 is rotationally secured to the tower structure 166 by radial bearing 168 and thrust bearing 170. A shaft coupling 130 couples the second transfer shaft 140 to a third transfer shaft 172. The wind pump tower has a man-lift assembly 174 with a man-lift platform 176, which facilitates access to the nacelle 82 (see FIG. 3) for maintenance. The wind pump tower 84 has a wind pump water tower 178 for storing surge volumes from the pump system 92 (see FIG. 5). The yaw gear assembly 154 is coupled to a yaw ring gear assembly 180, which is secured to the tower structure 166 by thrust bearing guide ring assembly 182. The tower structure 166 is secured to the pump tower base wall 184 by a tower attachment ring 186.

FIG. 5 is a schematic view of the wind pump tower base 86 of the wind pump 80 of FIG. 2. The third transfer shaft 172 is coupled to a pump connecting shaft 188 by a shaft coupling 130. The pump connecting shaft 188 is rotationally supported by radial bearing 190 and thrust bearing 192 and is coupled to centrifugal pump 194. In an exemplary embodiment the pump connecting shaft 188 provides an easily removable coupling between the third transfer shaft 172 and the centrifugal pump 194. In an exemplary embodiment, the first, second, and third transfer shafts 132, 140, 172, as well as the pump connecting shaft 188 are hollow.

The centrifugal pump 194 is secured to a tower foundation 196 by a multidirectional, adjustable mount 198 and isolation mounts 202. The centrifugal pump 194 converts torque delivered by the pump connecting shaft 188 into fluid energy (flow). In a preferred embodiment, the centrifugal pump 194 is a low head, high flow, vertically mounted centrifugal pump directly coupled to the pump connecting shaft 188 and the centrifugal pump 194 operates at a nearly constant discharge head, determined by the height of fluid in the water tower 62 (see FIG. 1). This increases the range of wind conditions that can be used over conventional wind generation systems. Mounting the centrifugal pump 194 in the wind pump tower base 86 facilitates maintenance, and helps to maintain net positive suction head.

The centrifugal pump 194 is coupled to a water return 204 through a first wind pump flow sensor 205, a first pump control valve 206 and a first pump isolation valve 208. The centrifugal pump 194 also is coupled to a water output 210 through a second pump isolation valve 212, a second pump control valve 214 and a second wind pump flow sensor 216. The centrifugal pump 194 also is coupled to the water pump water tower 178 through the second pump isolation valve 212, a third pump control valve 218, a high pressure pump 220 and a water pump water tower fill line 222. The wind pump tower base 86 has an air compressor 224 to supply control system air and high-pressure service air.

The first and second pump isolation valves 208, 212 allow disconnecting the wind pump 80 from a hydraulic system, such as the hydraulic system 72 illustrated in FIG. 1, for maintenance without having to secure the entire hydraulic system 72. The control valves 206 214, 218 function as check valves. The hydraulic system 72 will be operated at a generally constant pressure. In an exemplary embodiment, when the pressure at the centrifugal pump discharge 195 meets or exceeds system pressure, the control valves 206, 214, 218 will open, allowing fluid to flow from the centrifugal pump discharge 195 into the system. When pressure at the centrifugal pump discharge 195 falls below system pressure, the control valves 206, 214, 218 will close, preventing back flow through the centrifugal pump 194.

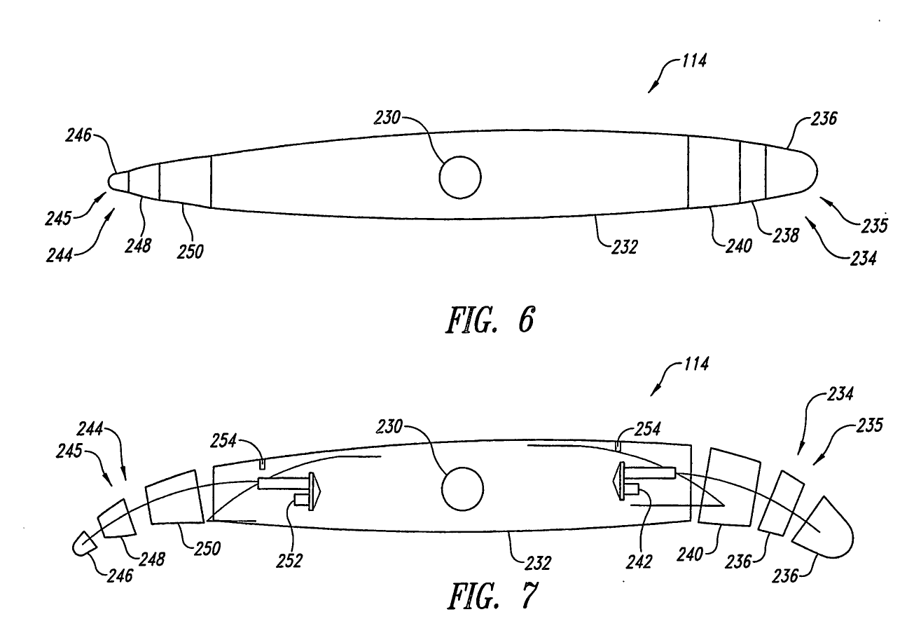

FIGS. 6 and 7 are partial cross sectional views of the wind blade 114 taken along lines 6, 7-6, 7 of FIG. 3. In FIG. 6 the wind blade 114 is illustrated in a closed position, while in FIG. 7 the wind blade 114 is illustrated in an open position. As discussed in more detail below, opening and closing the wind blade 114 changes the wind blade 114 profile, which allows for improved efficiency at various wind speeds. The wind blade 114 has a central shaft 230 and a main body 232.

The wind blade 114 also has a leading edge assembly 234 comprising an adjustable flap 235 with three leading edge segments 236, 238, 240 and a leading edge drive 242, which adjusts the position of the leading edge segments 236, 238, 240 of the flap 235. Similarly, the wind blade has a trailing edge assembly 244 comprising an adjustable flap 245 with three trailing edge segments 246, 248, 250 and a trailing edge drive 252, which adjusts the position of the trailing edge segments 246, 248, 250 of the flap 245. In an exemplary embodiment, the leading edge drive 242 and the trailing edge drive 252 are screw drives operated by electric motors inside the wind blade 114. The wind blade 114 has sensors 254, which sense operational conditions of the wind blade 114, such as the speed of the wind blade 114 and the position of the flaps 235, 245. The central shaft 230 may be hollow and contain signal and power lines (not shown) that couple to the sensors 254, the leading edge drive 242 or the trailing edge drive 252.

In an exemplary embodiment, the position of the flaps 235, 245 and the pitch angle of the wind blade 114 are automatically adjusted in concert for existing wind conditions. At high wind speeds, the flaps 235, 245 are retracted and the pitch angle is reduced to maintain torque within the limits of the wind pump 80 structure. At low wind speeds, the flaps 235, 245 are extended and the pitch angle is increased to increase torque. The combination of flap and pitch control facilitates operation at lower wind velocities. At very low wind velocities, if pitch is increased too far, the wind blade 114 will stall, producing no lift and hence, no torque. Using extendable flaps 235, 245 increases the range of wind speeds in which the wind pump 80 can be operated at a desired torque than if pitch alone were controlled.

After reviewing the specification, one of skill in the art will recognize that any suitable boundary layer control method or profile adjustment device may be employed, such as a plain flap, a split flap, a Fowler flap, a slotted flap, a fixed slot, an automatic slot, a boundary air suction device, or combinations thereof.

FIG. 8 illustrates a rotating power and control module 260 suitable for use with the embodiment of FIG. 1. The rotating power and control module 260 has a stationary frame 262, which can be secured to a nacelle housing (such as the nacelle housing 94 shown in FIG. 3). The stationary frame 262 houses the windings 264 of a primary coil 266 of a transformer 268. A power signal, a data signal or some combination thereof may be applied to the primary coil 266. A rotating power module shaft 270 is coupled to a blade drive shaft 272 (such as the blade drive shaft 96 of FIG. 3). A rotor core 274 is mounted to the rotating power module shaft 270 and houses the windings 276 of a secondary coil 278 of the transformer 268. The primary and secondary coil windings 264, 276 are concentric to the rotating power module shaft 270 to mitigate against the transformer acting as a motor and to allow a signal frequency applied to the transformer 268 to be independent of a rotational frequency of the rotating power module shaft 270. The thrust bearing 102 (see FIG. 3) mitigates against any force parallel to the rotating power module shaft. Additional thrust bearings may be employed.

A wireless communications module 280, a DC rectifier module 282, a remote-controlled circuit breaker box 284, and a local logic controller 286 are mounted to the rotating power module shaft 270. The wireless communication module 280 facilitates wireless communication between devices rotating with the blade drive shaft 272, such as the local logic controller 286, and a non-rotating control device, such as a control system 74 (see FIG. 1), blade control system 149 (see FIG. 3), or a main nacelle control 150 (see FIG. 3). The wireless communication module 280 may use any suitable protocol and the communications may be encrypted. The DC rectifier module 282 provides power required by devices rotating with the blade drive shaft 272, such as blade pitch control drive 118 (see FIG. 3) and blade edge drives 242, 252 (see FIG. 3). The DC rectifier module 282 may condition power, if desired. The remote-controlled circuit breaker box 286 provides protection against circuit overloads and can be remotely thrown or reset. The local logic controller 286 generates control signals to control the blade pitch control drive 118 (see FIG. 3) and edge drives 242, 252 (see FIG. 7). The rotating power module shaft has an end-plate 288.

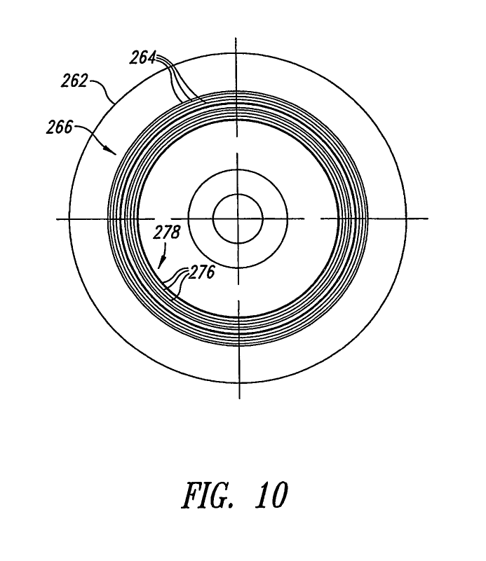

FIG. 9 shows a portion of the rotating power and control module 260 of FIG. 8 in greater detail. FIG. 10 is a partial cross-sectional view of the rotating power and control module of FIG. 8 taken along line 10-10, illustrating the concentric windings 264, 276 of the primary and secondary coils 266, 278.

The rotating power and control module 260 offers significant advantages over conventional slip rings and brushes. During periods of no wind, when the wind pump 80 and the blade drive shaft 96 are stationary, brushes would sit on the slip rings in one location for extended periods. This would result in a reaction between the brushes (usually a carbon compound) and the slip rings (usually copper). The result of this reaction would be an exchange of material between brush and slip ring. The deposited material would result in accelerated brush wear and could damage the slip rings, requiring increased maintenance. Also, weather conditions and the environment within the wind pump nacelle 82 could accelerate brush wear.

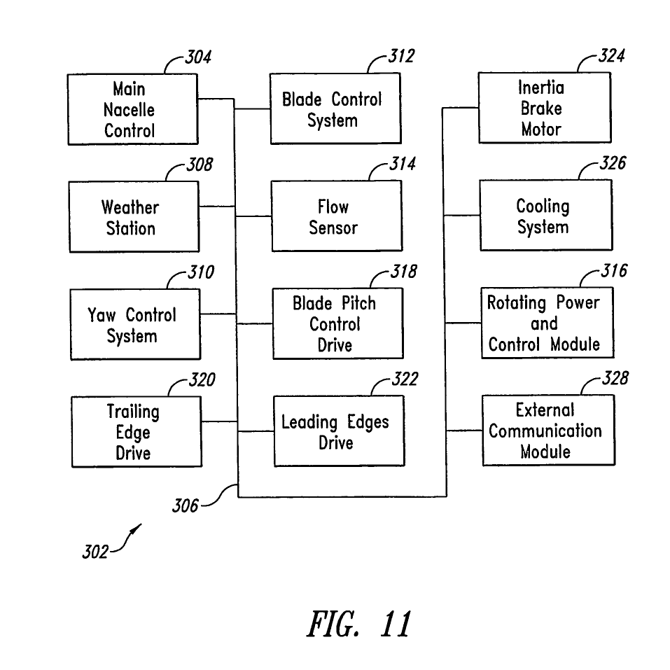

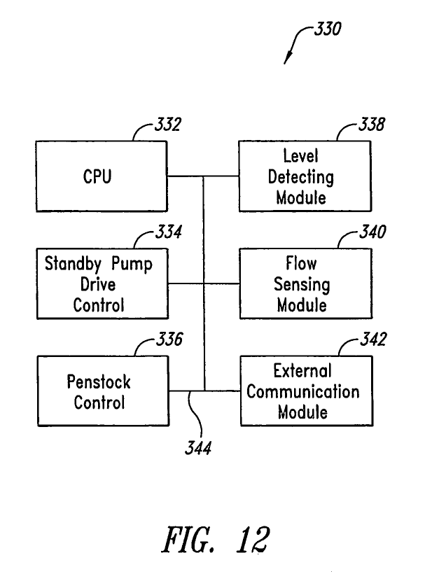

FIG. 11 is a functional block diagram of a nacelle control system 302 suitable for use with the embodiments of FIGS. 1 and 2. The nacelle control system 302 has a main nacelle control 304 for receiving data and control signals and for generating control signals for controlling components of a wind pump, such as wind pump 80 of FIG. 2. The main nacelle control 304 typically may be implemented with a CPU (not shown) and a memory (not shown). The main nacelle control 304 is coupled to a bus system 306. The bus system 306 provides power to components of the control system 302 and allows for transmission and reception of data and control signals by the components of the control system 302. The main nacelle control 304 receives data signals and generates control signals in response thereto. After reviewing the specification, one of skill in the art will recognize that the bus system 306 may include wireless communication links and inductive means of supplying power.

A weather station 308 coupled to the bus system 306 gathers weather-related information and generates data signals in response thereto. For example, the weather station 308 may measure a wind speed and direction, may take radar readings, and may receive signals containing weather-related information from a remote location and generate data signals in response thereto. The weather station 308 may also receive control signals, such as control signals from the main nacelle control 304 or from a remote location. (such as another wind pump 14 or a control system 74 (see FIG. 1)) requesting particular weather-related information, and may generate data signals in response thereto. Weather-related information gathered by the weather station 308 may also be used for predictive control of the standby pumps 28, 30 (see FIG. 1).

A yaw control system 310 coupled to the bus system 306 receives signals, such as control signals generated by the main nacelle control 304 or data signals generated by the weather station 308, and generates control signals for controlling a rotational position of the nacelle 82 (see FIG. 2) with respect to the pump tower 84.

A blade control system 312 is coupled to the bus system 306. The blade control system 312 generates control signals to control the pitch and the boundary layer characteristics of a wind blade 114 (see FIGS. 3, 6 and 7) in response to received signals, such as control signals generated by the main nacelle control 304 or data signals from the weather station 308.

A flow sensor 314 is coupled to the bus system 306 and generates data signals corresponding to the amount of fluid being pumped by the pump system 92.

A rotating power and control module 316 is coupled to the bus system 306. The rotating power and control module 316 permits wireless communication between the main nacelle control 304 and the blade control system 312 and the blade pitch control drive 318, the trailing edge drive 320 and the leading edge drive 322. The rotating power and control module 316 also facilitates providing power to components of the nacelle control system 302.

An inertia brake motor 324 and a cooling system 326 are coupled to the bus system 306 and receive control signals generated by the main nacelle control 304. An external communication module 328 is coupled to the bus system 306 and facilitates communication between the nacelle control system 302 and a remote location, such as the control system 74 illustrated in FIG. 1.

After reviewing the specification, one of skill in the art will recognize that components of the control system 302 can be combined. For example, the weather station 308 can be incorporated into the main nacelle control 304.

FIG. 12 is a functional block diagram of a main control system 330 suitable for use in the embodiment shown in FIG. 1. The main control system 330 has a CPU 332, which may have a memory (not shown), for receiving data and control signals and generating control signals in response thereto.

The main control system 330 has a standby pump drive control module 334 for monitoring and controlling one or more standby pump drives, such as the gas turbines 48 and 50 illustrated in FIG. 1. The standby pump drive control module 334 receives data signals, such as signals from the gas turbine speed sensor 53 shown in FIG. 1, and control signals from the CPU 332, and generates control signals for controlling one or more standby pumps.

The main control system 330 has a penstock control module 336 for monitoring and controlling a penstock, such as the inlet penstock 64 illustrated in FIG. 1. The penstock control module 336 receives data signals, such as data signals from the power sensor 76 illustrated in FIG. 1, and control signals from the CPU 332, and generates control signals for controlling an inlet penstock, such as the inlet penstock 64 illustrated in FIG. 1.

The main control system 330 has a level detecting module 338 for detecting fluid levels in a water tower, such as water tower 62 illustrated in FIG. 1. Alternatively, the level detecting module 338 may detect pressure levels in a hydraulic system, such as the hydraulic system 72 illustrated in FIG. 1, or may detect some combination of fluid levels and pressure levels. The main control system 330 has a flow-sensing module 340 for monitoring flow sensors in a hydraulic system, such as the hydraulic system 72 illustrated in FIG. 1, or in individual pumps systems, such as the pump system 92 illustrated in FIG. 2.

The main control system 330 has an external communications module 342 for sending and receiving control and data signals to and from remote locations, such as a remote weather station (see the weather station 146 of FIG. 3). Components of the main control system 330 are connected together by a bus system 344.

After reviewing the specification, one of skill in the art will recognize that the functions of various individual components of the main control system 330 can be integrated into the CPU 332.

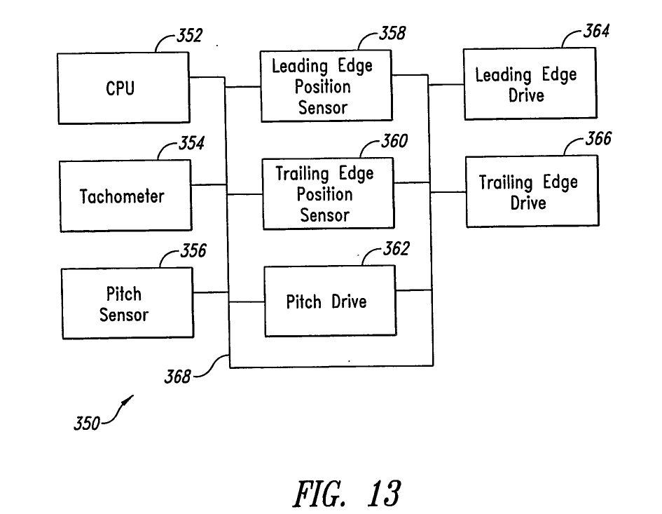

FIG. 13 is a functional block diagram of a blade control system 350 suitable for use with the wind pump embodiment illustrated in FIG. 2. The blade control system 350 has a CPU 352, which may have a memory (not shown), for receiving data and control signals and generating control signals in response thereto. For example, the CPU 352 may receive control and data signals from a main nacelle control or a weather station, such as the main nacelle control 150 or the weather station 146 illustrated in FIG. 3. The blade control system 350 has a blade speed tachometer 354 for measuring a speed of a wind blade, such as the wind blade 114 shown in FIG. 3, and generating a data signal in response thereto. The blade control system 350 has a blade pitch sensor 356 for determining the pitch of a blade, such as blade 114 of FIG. 3, and generating a data signal in response thereto. Similarly, the blade control system 350 has a leading edge position sensor 358 and a trailing edge position sensor 360 for determining the position of leading and trailing edge flaps, such as the leading and trailing edge flaps 235, 245 illustrated in FIGS. 6 and 7. The blade control system 350 has a pitch drive 362 for adjusting the pitch of a wind blade 114 (see FIG. 3), a leading edge drive 364 for adjusting the position of a leading edge flap 235, and a trailing edge drive 366 for adjusting the position of a trailing edge drive 245 in response to control signals generated by the CPU 352. The components of the blade control system are connected together by a bus system 368.

The CPU 352 may generate control signals to control the pitch drive 362, the leading edge drive 364 and the trailing edge drive 366 in response to control or data signals received from a remote location, or in response to data signals generated by the tachometer 354, the pitch sensor 356, the leading edge sensor 358 or the trailing edge sensor 360, or in response to some combination of data and control signals.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. An electric power generating system, comprising:
a hydraulic system;
a wind pump coupled to the hydraulic system and comprising:
an adjustable blade assembly;
a gearbox system coupled to the blade assembly; and
a fluid pump coupled to the gearbox system;
a standby fluid pump coupled to the hydraulic system;
a generator coupled to the hydraulic system; and
a control system for generating a control signal for controlling the standby fluid pump in response to a signal corresponding to a condition of the hydraulic system.

2. The electric power generating system of claim 1 wherein the blade assembly comprises an adjustable flap.

3. The electric power generating system of claim 1 wherein a pitch angle and a yaw of the blade assembly are adjustable.

4. The electric power generating system of claim 1 further comprising a transformer coupled to the blade assembly, the transformer having a first coil and a second coil rotatable with respect to the first coil.

5. The electric power generating system of claim 4 wherein the first coil is coupled to a power signal and the second coil is coupled to a blade assembly rectifier circuit.

6. The electric power generating system of claim 1 further comprising a second wind pump.

7. The electric power generating system of claim 1, further comprising a weather station coupled to the control system.

8. The electric power generating system of claim 1 wherein the standby fluid pump is powered by a turbine.

9. The electric power generating system of claim 1 wherein the hydraulic system comprises a tank for storing a fluid and the condition of the hydraulic system is a level of the fluid in the tank.

10. The electric power generating system of claim 1 wherein the condition of the hydraulic system is a pressure of a fluid in the hydraulic system.

11. The electric power generating system of claim 1 wherein the gearbox system comprises:
a first axle coupled to the blade assembly;
a gearbox coupled to the first axle;
a second axle coupled to the gearbox; and
a second gearbox coupled to the second axle, wherein the first axle and the second axle are substantially at right angles to one another.

12. The electric power generating system of claim 11 wherein the gearbox system further comprises a motor selectively coupleable to the gearbox.

13-59. (canceled)

60. A method of controlling a blade assembly for a wind pump, comprising:
receiving a signal; and
controlling a boundary layer characteristic of the blade assembly based on the received signal.

61-63. (canceled)

64. The method of claim 60 further comprising inductively supplying power to the blade assembly.

65. The method of claim 60 wherein receiving a signal comprises receiving a wireless communication signal.

66. The method of claim 65 wherein the wireless signal is encrypted.

67-68. (canceled)

69. A power transformer, comprising:
a stationary frame;
a rotatable shaft having an axis;
a primary coil mounted to the stationary frame and having windings concentric to the axis of the rotatable shaft; and
a secondary coil mounted to the rotatable shaft and having windings concentric to the axis of the rotatable shaft.

70. The power transformer of claim 69 further comprising a thrust bearing for rotatably mounting the rotatable shaft to the stationary frame.

71. The power transformer of claim 69 wherein the secondary coil is configured to receive a control signal.

72. The electric power generating system of claim 1 wherein the control system is configured to control the standby fluid pump so that a speed of the standby fluid pump is increased in response to a signal corresponding to a condition of the hydraulic system.
